(19) United States
(12) Patent Application Publication
(10) Pub. No.: US 2019/0256265 A1
(43) Pub. Date: Aug. 22, 2019

(54) Disposable container produced with oxo-biodegradable material and preparing method thereof

(71) Applicant: Shun Ming Daniel Wong, Hong Kong (CN)

(72) Inventor: Shun Ming Daniel Wong, Hong Kong (CN)

(21) Appl. No.: 16/398,265

(22) Filed: Apr. 30, 2019

(30) Foreign Application Priority Data
May 4, 2018 (HK) 18105807.2

(51) Int. Cl. B65D 65/46; D21H 19/22; D21H 25/06

(52) U.S. Cl. CPC B65D 65/466; B29B 13/022; D21H 25/06; D21H 19/22

(57) ABSTRACT

The present invention discloses a disposable container produced with oxo-biodegradable material. The preparing method is as below: placing PE granules and oxo-biodegradable granules into a mixer; stirring a mixture of the PE granules and the oxo-biodegradable granules completely for 30 minutes; adding the mixture into a heater; increasing the temperature from 100 to 300 degree; dissolving the mixture into a liquid; laminating the liquid on paper; cooling laminated paper in a cooler; sending the laminated paper into a printing press; printing the laminated paper with a water-based ink; cutting the laminated paper by a cutter into a container; shaping the container in a machine; and producing a finished container. The plastic granule on the surface of the laminated paper is bio-degraded and is transferred from high molecular weight into low molecular weight before microorganism transferring the low molecular plastic granule into water, carbon dioxide and biomass.

### CROSS REFERENCE OF RELATED APPLICATION

The application claims priority under 35 U.S.C. 119(a-d) to HK18105807.2, filed May 4, 2018.

### BACKGROUND OF THE PRESENT INVENTION

### Field of Invention

The present invention relates to a disposable container produced with oxo-biodegradable material, such as paper cups, paper plates or paper bowls.

### Description of Related Arts

The disposable cups are more and more demanding with the change of people's lifestyle. The disposable cup is one of the important daily commodities, especially in public place with huge passenger volume. The conventional plastic cup is widely adopted for the advantages of light in weight and convenient for use. The recycling of the plastic cup is very difficult, which induce the use of a disposable container with PE laminated surface. The disposable container is able to hold the food, drinks and beverages without leakage and is convenient for recycling. But inside the container there are a layer of residue PE laminating, which endanger the health of the consumer and bring huge damage to the consumer and the environment.

### SUMMARY OF THE PRESENT INVENTION

An object of the present invention is to provide a disposable container produced with oxo-biodegradable material, which prevent the consumers' health being damaged and is environment friendly and easy for recycling.

In order to solve the problems of the conventional disposable containers, the present invention provides a disposable container with oxidational-biodegradable. The method comprises the following steps: placing PE(polyethylene) granules and oxo-biodegradable granules into a mixer; stirring a mixture of the PE granules and the oxo-biodegradable granules completely for 30 minutes; adding the mixture into a heater; increasing a temperature from 100 degree to 300 degree; dissolving the mixture into a liquid which contains PE; laminating the liquid on a surface of paper; cooling laminated paper in a cooler; sending the laminated paper into a printing press after being cooled down; printing the laminated paper with a water-based ink according to different needs; cutting the laminated paper by a cutter into a container after the laminated paper being printed; shaping the container in a machine for processing the container; and producing a finished container. The container is a paper cup, paper plate or paper bowl.

Furthermore, a mess fraction of the PE granule is 99% and a mess fraction of the oxo-biodegradable granule is 1%; the PE granule and the oxo-biodegradable granule are mixed together and dissolved into the liquid which contains PE before laminating on the surface of the paper.

The present invention adopts a liquid contains PE to laminate the paper, which first oxidize and then biodegrades the plastic granule on the surface of the laminated paper and transfers the plastic granule from high molecular weight to low molecular weight. According to the rules of the ASTM d6954 (American Society for Testing and Materials), the molecular weight of the plastic is lower than 5000, the low molecular weight plastic is transferred by the microorganism to water, carbon dioxide and biomass. The present invention has the advantages in preventing the damage of the environment while use, environment-friendly and easy for recycling.

### DETAILED DESCRIPTION OF THE PREFERRED EMBODIMENT

In order to better illustrate the present invention, with reference of the embodiment, the present invention is described in detail. The embodiment is just for illustrating the present invention not a limitation.

An embodiment is adopted to illustrate the present invention, wherein the method comprises the following steps: placing PE(polyethylene) granules and oxo-biodegradable granules into a mixer; stirring a mixture of the PE granules and the oxo-biodegradable granules completely for 30 minutes; adding the mixture into a heater; increasing a temperature from 100 degree to 300 degree; dissolving the mixture into a liquid which contains PE; laminating the liquid on a surface of paper; cooling laminated paper in a cooler; sending the laminated paper into a printing press after being cooled down; printing the laminated paper with a water-based ink according to different needs; cutting the laminated paper by a cutter into a container after the laminated paper being printed; shaping the container in a machine for processing the container; and producing a finished container. The container is a disposable a paper cup, a paper plate or a paper bowl for catering.

In the embodiment a mess fraction of the PE granule is 99% and a mess fraction of the oxo-biodegradable granule is 1%; the PE granule and the oxo-biodegradable granule are mixed together and dissolved into the liquid which contains PE before laminating on the surface of the paper.

The liquid which contains PE is constructed with oxidation-biodegradation material. The oxidation-biodegradation material first oxidize and then biodegrade the plastic granule. The molecular weight of the conventional plastic granule of the container is too high for degrading by microorganism. The present invention add addictive to transfer the plastic from high molecular weight to low molecular before the microorganism transferring the plastic to water, carbon dioxide and biomass. The present invention follows the rules of ASTM d6954 d6954 (American Society for Testing and Materials) and the molecular weight of the plastic is lower than 5000.

The container produced with oxidation-biodegradation material is mainly used in home, restaurant and factory. In China, over 10 billion containers are used and the volume grows by a double-digit. The present invention reduces the investment on waste treatment and brings a win-win solution for an environment friendly life style. The present invention is able to recycle the disposable container and reduce the waste. The disposable container produced with the oxidation-degradable material of the present invention has the below benefits: no new machine needed to produce the disposable container, which is able to take full advantages of the current machines; no changes on the appearance and physical features of the container; no obvious increase in cost; reduce the investment in waste treatment. The present invention meets the requirements of the main domestic and aboard regulations on food security and heavy metal.

The present invention adopts a liquid contains PE to laminate the paper, which first oxidize and then biodegrades the plastic granule on the surface of the laminated paper and transfers the plastic granule from high molecular weight to low molecular weight. According to the rules of the ASTM d6954 (American Society for Testing and Materials), the molecular weight of the plastic is lower than 5000, the low molecular weight plastic is transferred by the microorganism to water, carbon dioxide and biomass. The present invention has the advantages in preventing the damage of the environment while use, environment-friendly and easy for recycling.

The embodiment of the present invention is exemplary only and not intended to be limiting. The modifications and alterations without new creative ideas by one skilled in the art are within the protection range of the present invention.

What is claimed is:

1. A process for producing a container with a oxo-biodegradable material, comprising the following steps of: placing PE(polyethylene) granules and oxo-biodegradable granules into a mixer; stirring a mixture of the PE granules and the oxo-biodegradable granules thoroughly for 30 minutes; adding the mixture into a heater; increasing a temperature from 100 degrees to 300 degrees; dissolving the mixture into a liquid which contains PE; laminating the liquid on a surface of paper; cooling laminated paper in a cooler; sending the laminated paper into a printing press after being cooled down; printing the laminated paper with a water-based ink according to different needs; cutting the laminated paper by a cutter into a container after the laminated paper being printed; shaping the container in a machine for processing the container; and producing a finished container.

2. A container with an oxo-biodegradable material, wherein a mess fraction of PE granules is 99% and a mess fraction of oxo-biodegradable granules is 1%; the PE granules and the oxo-biodegradable granules are mixed together and dissolved into a liquid which contains PE before laminating on a surface of the paper.

3. The container with the oxo-biodegradable material, as recited in claim 2, wherein the finished container is a paper cup, a paper plate or a paper bowl.
